(19) United States
(12) Patent Application Publication
(10) Pub. No.: US 2024/0419371 A1
(43) Pub. Date: Dec. 19, 2024

(54) INFORMATION PROCESSING SYSTEM AND NON-TRANSITORY COMPUTER READABLE MEDIUM

(71) Applicant: FUJIFILM BUSINESS INNOVATION CORP., Tokyo (JP)

(72) Inventor: Masahiro YASUI, Kanagawa (JP)

(73) Assignee: FUJIFILM BUSINESS INNOVATION CORP., Tokyo (JP)

(21) Appl. No.: 18/519,314

(22) Filed: Nov. 27, 2023

(30) Foreign Application Priority Data
Jun. 14, 2023 (JP) 2023-098053

(51) Int. Cl. G06F 3/12

(52) U.S. Cl. CPC G06F 3/121; G06F 3/1234

(57) ABSTRACT

An information processing system includes a communication unit and a processor configured to transmit an execution instruction when the communication unit receives a resolution request to resolve communication trouble from another information processing system in a case where the other information processing system is unable to communicate with a device prioritized to communicate with when the other information processing system resolves trouble, the execution instruction being an instruction to execute a resolution operation to resolve the trouble from the communication unit to the other information processing system.

### CROSS-REFERENCE TO RELATED APPLICATIONS

This application is based on and claims priority under 35 USC 119 from Japanese Patent Application No. 2023-098053 filed Jun. 14, 2023.

### BACKGROUND

### (i) Technical Field

The present disclosure relates to an information processing system and a non-transitory computer readable medium.

### (ii) Related Art

Japanese Patent No. 6886791 discloses a communication device provided to an information processing device, the communication device characterized by including: generating means for generating status information indicating the status of the host information processing device; transmitting and receiving means for transmitting and receiving the status information of the host and other information processing devices to and from the other information processing devices connected to each other via a mesh network; sharing means for sharing the status information of other information processing devices obtained by the transmitting and receiving means together with the status information of the host information processing device generated by the generating means; and outputting means for receiving a request from any of multiple server devices and outputting to the multiple server devices the status information shared by the sharing means.

### SUMMARY

In a situation where an information processing system resolves trouble occurring in the information processing system through a method of communicating with a device prioritized to communicate with when resolving trouble and directly receiving from the device an execution instruction to execute a resolution operation to resolve the trouble, the trouble may not be resolvable if the information processing system is unable to communicate with the device.

Aspects of non-limiting embodiments of the present disclosure relate to enabling an information processing system to resolve trouble occurring in the information processing system, even if communication is unavailable with a device prioritized to communicate with when resolving trouble.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a communication unit and a processor, wherein the processor is configured to transmit an execution instruction when the communication unit receives a resolution request to resolve communication trouble from another information processing system in a case where the other information processing system is unable to communicate with a device prioritized to communicate with when the other information processing system resolves trouble, the execution instruction being an instruction to execute a resolution operation to resolve the trouble from the communication unit to the other information processing system.

### BRIEF DESCRIPTION OF THE DRAWINGS

An exemplary embodiment of the present disclosure will be described in detail based on the following figures, wherein:

FIG. 1 is a schematic diagram illustrating an executing system according to an exemplary embodiment;

FIG. 2 is a block diagram illustrating an example of a hardware configuration of a first multi-function device according to the exemplary embodiment;

FIG. 3 is a block diagram illustrating an example of a functional configuration of a control device of the first multi-function device according to the exemplary embodiment;

FIG. 4 is a block diagram illustrating an example of a hardware configuration of a second multi-function device according to the exemplary embodiment;

FIG. 5 is a block diagram illustrating an example of a functional configuration of a control device of the second multi-function device according to the exemplary embodiment;

FIG. 6 is a block diagram illustrating an example of a hardware configuration of a server device according to the exemplary embodiment;

FIG. 7 is a block diagram illustrating an example of a functional configuration of a control device of the server device according to the exemplary embodiment;

FIG. 8 is a flowchart illustrating an example of the flow of a trouble resolution process according to the exemplary embodiment;

FIG. 9 is a diagram illustrating an example of an information list indicating details about communication trouble transmitted from the first multi-function device to the second multi-function device according to the exemplary embodiment;

FIG. 10 is a diagram illustrating an example of an information list indicating the content of an execution instruction transmitted from the first server device to the second multi-function device according to the exemplary embodiment; and

FIG. 11 is a flowchart illustrating an example of the flow of a trouble resolution process according to an exemplary modification.

### DETAILED DESCRIPTION

Hereinafter, an exemplary embodiment of the present disclosure will be described on the basis of the drawings.

### <Executing System 10>

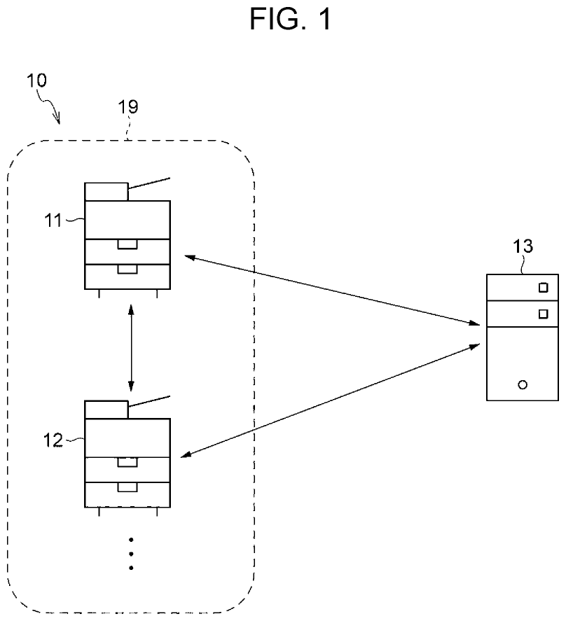

First, an executing system 10 according to the exemplary embodiment will be described. FIG. 1 is a schematic diagram illustrating the executing system 10 according to the exemplary embodiment.

The executing system 10 executes information processing, including a trouble resolution process described later, as a predetermined process, and as illustrated in FIG. 1, is provided with a first multi-function device 11, multiple second multi-function devices 12, and a server device 13. In other words, the executing system 10 is provided with multiple (specifically, three or more) multi-function devices (specifically, the first multi-function device 11 and the second multi-function devices 12) and the server device 13. The first multi-function device 11, the multiple second multi-function device 12, and the server device 13 are capable of communicating with each other over a network.

### <First Multi-Function Device 11>

The first multi-function device 11 is an example of an information processing system that processes information, and may also be referred to as an information processing device that processes information. Note that when taking a second multi-function device 12 as an example of an information processing system, the first multi-function device 11 may be understood as an example of another information processing system.

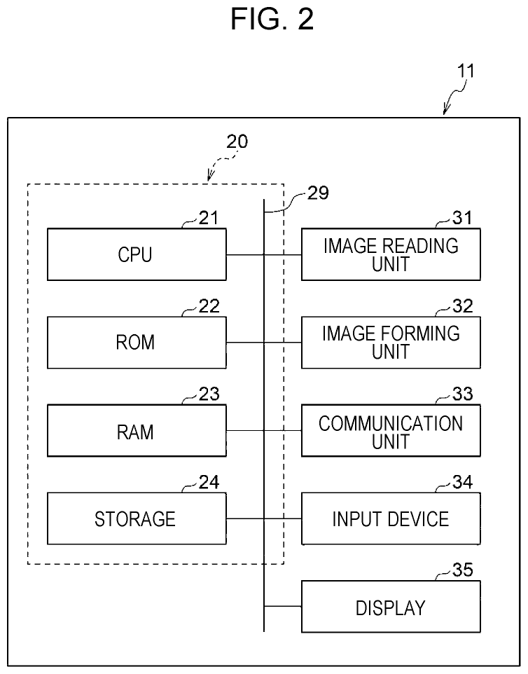

The first multi-function device 11 is capable of executing processes such as copy, print, scan, and facsimile processes. Specifically, as illustrated in FIG. 2, the first multi-function device 11 is provided with a control device 20, an image reading unit 31, an image forming unit 32, a communication unit 33, an input device 34, and a display 35.

The image reading unit 31 is a component (for example, a scanner) that reads an image of a document. The image reading unit 31 optically reads and converts an image of a document into a digital signal, thereby generating image data. Note that an image may contain text.

The image forming unit 32 is a component that forms an image onto a recording medium such as paper. The image forming unit 32 forms an image onto a recording medium according to an electrophotographic system in which the steps of charging, exposing, developing, transferring, and fusing are performed, for example. Note that the image forming unit 32 may also form an image onto a recording medium according to another system, such as an inkjet system.

The communication unit 33 is a component for communicating with other equipment such as the multiple second multi-function devices 12, the server device 13, and other multi-function devices. Specifically, the communication unit 33 communicates with other equipment through the use of means of communication such as a wired connection, a wireless connection, the Internet, an intranet, or a public circuit such as a telephone circuit. Note that the means of communication may also be means of communication using sound or speech, light, vibration, images, and the like.

In the exemplary embodiment, the communication unit 33 communicates with, for example, the server device 13 over a network (for example, the Internet) allowing any terminal to connect. Communication between the communication unit 33 and the server device 13 (specifically, a communication unit 333 described later) is assumed to be communication that requires certificate verification.

The communication unit 33 also communicates with the second multi-function devices 12 over a closed network 19 (for example, a LAN or other local network) allowing a specific terminal to connect, for example. Communication between the communication unit 33 and the second multi-function devices 12 (specifically, a communication unit 233 described later) is assumed to be communication that does not require certificate verification.

In the first multi-function device 11, a scan process is executed by, for example, causing the image reading unit 31 to read an image of a document and generate image data. In the first multi-function device 11, a facsimile process is executed by, for example, transmitting image data generated by reading an image of a document with the image reading unit 31 to another piece of equipment, such as another all-in-one machine.

In the first multi-function device 11, a copy process is executed by, for example, causing the image forming unit 32 to form an image onto a recording medium such as paper on the basis of image data generated by reading an image of a document with the image reading unit 31. In the first multi-function device 11, a print process is executed by, for example, causing the image forming unit 32 to form an image onto a recording medium such as paper on the basis of image data obtained from a terminal such as a personal computer or a smartphone, from a recording medium such as USB memory, or the like.

The input device 34 is a component that accepts instructions inputted by the user. Specifically, the input device 34 is configured as input keys (such as a keyboard and operation buttons, for example) and a touch panel on which the user performs input operations, for example.

Instructions given by the user may be execution instructions causing the first multi-function device 11 to execute a job involving processes such as copy, print, scan, and facsimile processes. A job refers to a unit of processing for operations to be executed according to a single instruction from the user.

The display 35 is an example of a notifier, and displays presentation information to be presented to the user, thereby notifying the user of the presentation information. The display 35 may be configured as a liquid crystal display or an organic light-emitting diode display, for example.

Note that the display 35 may also function as the input device 34. In this case, the input device is configured as a resistive, capacitive, or other type of touch panel, and the user inputs instructions by performing touch operations, for example.

The control device 20 controls each unit of the first multi-function device 11. The control device 20 functions as a computer, and as illustrated in FIG. 2, includes a central processing unit (CPU) 21, read-only memory (ROM) 22, random access memory (RAM) 23, and storage 24. The CPU 21, ROM 22, RAM 23, and storage 24 are interconnected by a bus 29.

The CPU 21 is a central processing unit that executes various programs, including information processing programs such as a trouble resolution program, and controls each unit. The ROM 22 stores various programs, including information processing programs, and various data. The RAM 23 temporarily stores programs or data as a work area. The storage 24 includes a storage medium such as a hard disk drive (HDD), a solid-state drive (SSD), or flash memory, and stores various programs, including an operating system, and various data. Note that information processing programs may also be stored in the storage 24.

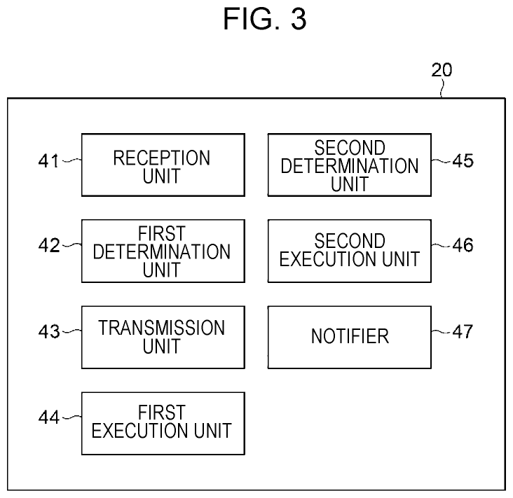

In the control device 20, the CPU 21 reads out various programs, including information processing programs, from the ROM 22 or the storage 24, and executes the programs while using the RAM 23 as a work area. By executing the information processing programs, the CPU 21 achieves various functions for controlling each unit of the first multi-function device 11. Hereinafter, a functional configuration achieved through cooperation between the CPU 21 serving as a hardware resource and the information processing programs serving as a software resource will be described. FIG. 3 is a block diagram illustrating an example of a functional configuration of the control device 20 according to the exemplary embodiment.

In the control device 20, the CPU 21 executes an information processing program to thereby function as a reception unit 41, a first determination unit 42, a transmission unit 43, a first execution unit 44, a second determination unit 45, a second execution unit 46, and a notifier 47, as illustrated in FIG. 3.

The CPU 21 is capable of accepting a job execution instruction from the user, and the reception unit 41 accepts a job execution instruction from the user through the input device 34.

The first determination unit 42 determines whether the communication unit 33 is able to communicate with the server device 13 (specifically, the communication unit 333), which is a device prioritized to communicate with when the first multi-function device 11 resolves trouble.

If the first determination unit 42 determines that communication is unavailable between the server device 13 and the communication unit 33, the transmission unit 43 transmits a resolution request to resolve trouble (specifically, the trouble causing communication to be unavailable (hereinafter referred to as communication trouble)) and details about the communication trouble from the communication unit 33 to the second multi-function device 12 (specifically, the communication unit 233).

When the communication unit 33 receives from the second multi-function device 12 an execution instruction to execute a resolution operation to resolve the trouble, the first execution unit 44 executes the resolution operation.

If the first determination unit 42 has determined that communication is unavailable between the server device 13 and the communication unit 33, and the reception unit 41 accepts a job execution instruction from the user, the second determination unit 45 determines whether the job involves communication with the server device 13.

If the second determination unit 45 determines that the job does not involve communication with the server device 13, the second execution unit 46 executes the job before the resolution operation is executed. On the other hand, if the second determination unit 45 determines that the job involves communication with the server device 13, the second execution unit 46 executes the job after the resolution operation is executed.

If the second determination unit 45 determines that the job involves communication with the server device 13, the notifier 47 notifies the user via the display 35 that the job is unavailable for execution until the trouble is resolved.

### <Second Multi-Function Devices 12>

The second multi-function device 12 are each an example of an information processing system that processes information, and may also be referred to as an information processing device that processes information. Note that when taking the first multi-function device 11 as an example of an information processing system, each second multi-function device 12 may be understood as an example of a different information processing system.

The second multi-function devices 12 are configured similarly to the first multi-function device 11, and each is capable of executing processes such as copy, print, scan, and facsimile processes. In the following, the portions of the second multi-function devices 12 that differ from the first multi-function device 11 will be described, and the similar portions will be omitted from description where appropriate.

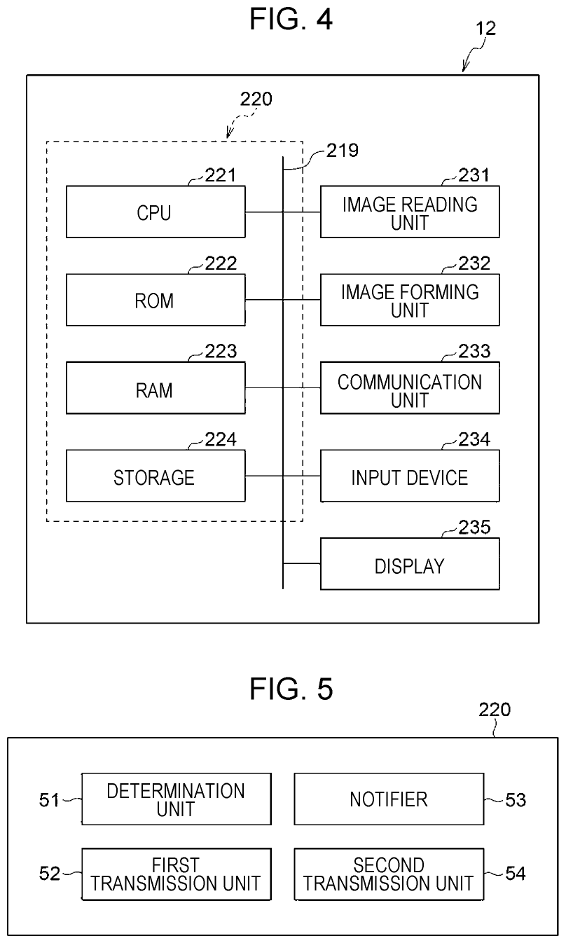

Specifically, as illustrated in FIG. 4, each second multi-function device 12 is provided with a control device 220, an image reading unit 231, an image forming unit 232, a communication unit 233, an input device 234, and a display 235.

The control device 220 functions as a computer, and as illustrated in FIG. 4, includes a central processing unit (CPU) 221, read-only memory (ROM) 222, random access memory (RAM) 223, and storage 224. The CPU 221, ROM 222, RAM 223, and storage 224 are interconnected by a bus 219.

The control device 220, image reading unit 231, image forming unit 232, communication unit 233, input device 234, display 235, CPU 221, ROM 222, RAM 223, storage 224, and bus 219 in the second multi-function devices 12 are configured similarly to the control device 20, image reading unit 31, image forming unit 32, communication unit 33, input device 34, display 35, CPU 21, ROM 22, RAM 23, storage 24, and bus 29 in the first multi-function device 11.

In the control device 220, the CPU 221 executes an information processing program to thereby function as a determination unit 51, a first transmission unit 52, a notifier 53, and a second transmission unit 54, as illustrated in FIG. 5.

When communication is unavailable between the server device 13 and the first multi-function device 11, and the communication unit 233 receives from the first multi-function device 11 a resolution request to resolve communication trouble and details about the communication trouble, the determination unit 51 determines whether the communication unit 233 is able to communicate with the server device 13 (specifically, the communication unit 333).

If the determination unit 51 determines that the communication unit 233 is able to communicate with the server device 13, the first transmission unit 52 transmits the resolution request and the details about the communication trouble from the communication unit 233 to the server device 13.

In other words, if the communication unit 233 receives the resolution request from the first multi-function device 11 while the communication unit 233 is able to communicate with the server device 13, the first transmission unit 52 transmits the resolution request and the details about the communication trouble from the communication unit 233 to the server device 13.

If the determination unit 51 determines that the communication unit 233 of the second multi-function device 12 is unable to communicate with the server device 13, the notifier 53 notifies the user, via one or both of the display 235 of the second multi-function device 12 and the display 35 of the first multi-function device 11, of the possibility of trouble on the network including the communication unit 233 and the communication unit 33 of the first multi-function device 11.

When the communication unit 233 receives the execution instruction from the server device 13, the second transmission unit 54 transmits the execution instruction from the communication unit 233 to the first multi-function device 11. Specifically, when transmitting the execution instruction to the first multi-function device 11, the second transmission unit 54 transmits the execution instruction, together with a transmission instruction to transmit to the communication unit 233 an execution result of executing the execution instruction, from the communication unit 233 to the first multi-function device 11.

### <Server Device 13>

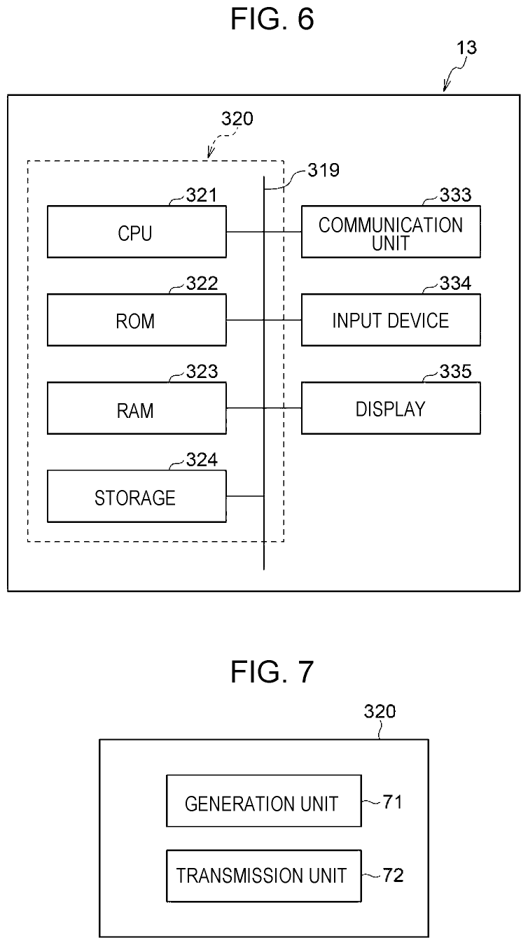

The server device 13 is an example of a device prioritized to communicate with when the first multi-function device 11 resolves trouble, and may also be referred to as an information processing device that processes information. Specifically, as illustrated in FIG. 6, the server device 13 is provided with a control device 320, a communication unit 333, an input device 334, and a display 335.

The control device 320 functions as a computer, and as illustrated in FIG. 6, includes a central processing unit (CPU) 321, read-only memory (ROM) 322, random access memory (RAM) 323, and storage 324. The CPU 321, ROM 322, RAM 323, and storage 324 are interconnected by a bus 319.

The control device 320, communication unit 333, input device 334, display 335, CPU 321. ROM 322, RAM 323, storage 324, and bus 319 in the server device 13 are configured similarly to the control device 20, communication unit 33, input device 34, display 35, CPU 21, ROM 22, RAM 23, storage 24, and bus 29 in the first multi-function device 11.

In the exemplary embodiment, the server device 13 functions as a management server that manages each of the first multi-function device 11 and the multiple second multi-function devices 12. In the server device 13, the CPU 321 is configured to acquired, through the communication unit 333, various information about each multi-function device (for example, various software such as firmware, remaining consumables, replacement times for parts, and the presence or absence of errors) from each of the first multi-function device 11 and the multiple second multi-function devices 12. Additionally, the CPU 321 executes a predetermined process with respect to each multi-function device (for example, updating various software, making arrangements for consumables and parts, and issuing execution instructions for operations to resolve errors) on the basis of the various information about each multi-function device.

Additionally, in the control device 320, the CPU 321 executes an information processing program to thereby function as a generation unit 71 and a transmission unit 72, as illustrated in FIG. 7.

When the communication unit 333 receives a resolution request to resolve communication trouble and details about the communication trouble from the second multi-function device 12, the generation unit 71 generates an execution instruction for a resolution operation to resolve the communication trouble and a transmission instruction to transmit to the communication units 233 and 333 an execution result of executing the execution instruction.

The transmission unit 72 transmits the execution instruction and transmission instruction generated by the generation unit 71 from the communication unit 333 to the second multi-function device 12 (specifically, the communication unit 233).

### <Trouble Resolution Process in Executing System 10>

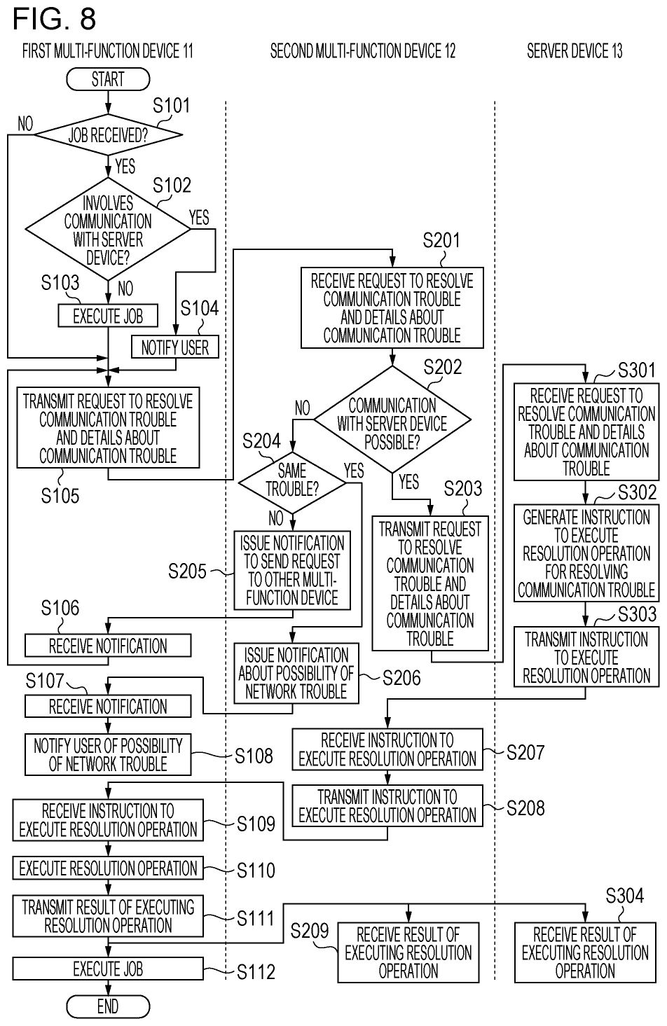

Next, a trouble resolution process executed in the executing system 10 will be described. FIG. 8 is a flowchart illustrating an example of the flow of a trouble resolution process in the exemplary embodiment.

In the first multi-function device 11, the CPU 21 determines whether the communication unit 33 is able to communicate with the server device 13 (specifically, the communication unit 333), and if the CPU 21 determines that the communication unit 33 is unable to communicate with the communication unit 333, the executing system 10 executes the trouble resolution process.

In the exemplary embodiment, the CPU 21 of the first multi-function device 11 reads out a trouble resolution program from the ROM 22 or the storage 24, the CPU 221 of the second multi-function device 12 reads out a trouble resolution program from the ROM 222 or the storage 224, the CPU 321 of the server device 13 reads out a trouble resolution program from the ROM 322 or the storage 324, and the CPUs 21, 221, and 321 cooperatively execute the trouble resolution programs to thereby execute the trouble resolution process.

As illustrated in FIG. 8, when the trouble resolution process starts, the CPU 21 determines whether a job execution instruction is received (step S101).

In the case of determining that a job execution instruction is not received (step S101: NO), the CPU 21 proceeds to step S105, whereas in the case of determining that a job execution instruction is received (step S101: YES), the CPU 21 determines whether the job involves communication with the server device 13 (step S102).

In the case of determining that the job does not involve communication with the server device 13 (step S102: NO), the CPU 21 executes the job (step S103) and proceeds to step S105.

On the other hand, in the case of determining that the job involves communication with the server device 13 (step S102: YES), the CPU 21 notifies the user via the display 35 that the job is unavailable for execution until the communication trouble is resolved (step S104) and proceeds to step S105.

In step S105, the CPU 21 transmits a resolution request to resolve the communication trouble and details about the communication trouble from the communication unit 33 to the second multi-function device 12 (specifically, the communication unit 233). Accordingly, at the second multi-function device 12, the communication unit 233 receives the resolution request and the details about the communication trouble from the first multi-function device 11 (step S201).

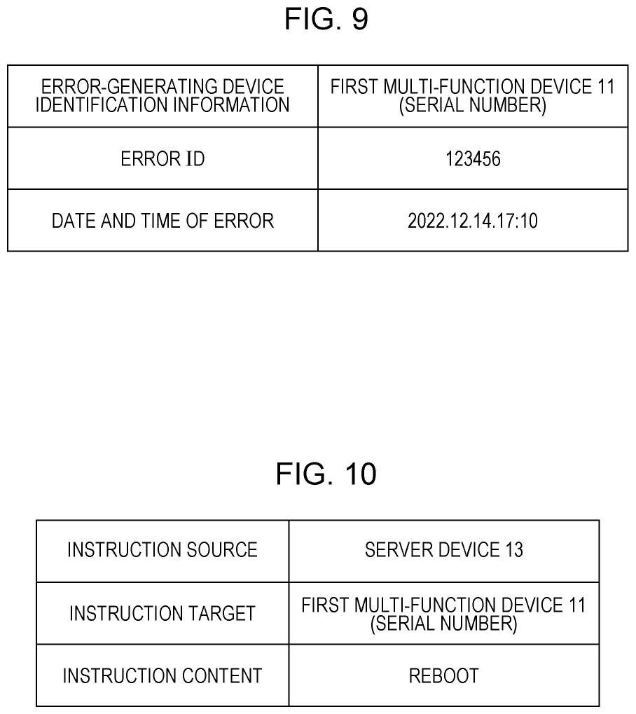

As illustrated in FIG. 9, information indicating the details about the communication trouble transmitted from the second multi-function device 12 may be identification information of the device in which the communication trouble is occurring (the error-generating device in FIG. 9), details about the communication trouble (the error ID in FIG. 9), and the date and time when the communication trouble occurred (the date and time of error in FIG. 9).

When the communication unit 233 receives the resolution request and the details about the communication trouble from the first multi-function device 11, the CPU 221 determines whether the communication unit 233 is able to communicate with the server device 13 (specifically, the communication unit 333) (step S202).

In the case of determining that the communication unit 233 is able to communicate with the communication unit 333 (step S202: YES), the CPU 221 proceeds to step S203, whereas in the case of determining that the communication unit 233 is unable to communicate with the communication unit 333 (step S202: NO), the CPU 221 proceeds to step S204.

In step S204, the CPU 221 determines whether the communication trouble of the communication unit 33 with respect to the server device 13 (specifically, the communication unit 333) and the communication trouble of the communication unit 233 with respect to the server device 13 (specifically, the communication unit 333) are the same trouble.

In the case of determining that the communication trouble of the communication unit 33 with respect to the communication unit 333 and the communication trouble of the communication unit 233 with respect to the communication unit 333 are different troubles (step S204: NO), the CPU 221 notifies the first multi-function device 11 to send a resolution request to another second multi-function device 12 (step S205).

At the first multi-function device 11, when the communication unit 33 receives the notification (step S106), the CPU 21 returns to step S105 and transmits, with respect to another multi-function device (that is, another second multi-function device 12), a resolution request and details about the communication trouble from the communication unit 33 to the second multi-function device 12 (specifically, the communication unit 233).

In step S204, if the CPU 221 determines that the communication trouble of the communication unit 33 with respect to the server device 13 (specifically, the communication unit 333) and the communication trouble of the communication unit 233 with respect to the server device 13 (specifically, the communication unit 333) are the same trouble (step S204: YES), the CPU 221 notifies the first multi-function device 11 of the possibility of trouble on the network including the communication unit 233 of the second multi-function device 12 and the communication unit 33 of the first multi-function device 11 (step S206).

At the first multi-function device 11, when the communication unit 33 receives the notification (step S107), the CPU 21 presents the notification to the user via the display 35 of the first multi-function device 11 (step S108). Note that the notification may also be presented to the user via the display 235 of the second multi-function device 12 instead or, or in addition to, the notification on the display 35. The display 35 may also display the notification when the user performs an operation (such as an input operation with respect to the input device 34, for example) on the first multi-function device 11.

In step S203, the CPU 221 transmits a resolution request to resolve the communication trouble and details about the communication trouble from the communication unit 233 to the server device 13 (specifically, the communication unit 333).

Accordingly, at the server device 13, the communication unit 333 receives the resolution request and the details about the communication trouble from the second multi-function device 12 (step S301). When the communication unit 333 receives a resolution request to resolve communication trouble and details about the communication trouble from the second multi-function device 12, the CPU 321 generates an execution instruction for a resolution operation to resolve the communication trouble and a transmission instruction to transmit to the communication units 233 and 333 an execution result of executing the execution instruction (step S302).

The resolution operation is an operation for restoring the first multi-function device 11 in which the communication trouble is occurring to a state that allows for communication with the server device 13. The resolution operation may be, for example, a reboot operation to reboot, an acquisition operation to acquire a certificate required for communication, or a reconfiguration operation to reconfigure settings.

In the exemplary embodiment, the CPU 321 may generate the execution instruction and the transmission instruction on the basis of an execution instruction and a transmission instruction that an engineer or other person giving instructions has inputted via the input device 334 according to the details about the communication trouble, for example.

The storage 324 may also retain in advance a list of information on resolution operations corresponding to each of multiple communication troubles, and the CPU 321 may generate the execution instruction and the transmission instruction by selecting from the information list a resolution operation corresponding to the communication trouble pertaining to the resolution request.

As illustrated in FIG. 10, information indicating the content of the execution instruction transmitted from the second multi-function device 12 may be the instruction source, the instruction target, and the instruction content. Note that FIG. 10 illustrates an example in which the instruction source is the server device 13, the instruction target is the first multi-function device 11, and the instruction content is a reboot.

Next, the CPU 321 transmits the execution instruction and transmission instruction for the resolution operation from the communication unit 333 to the second multi-function device 12 (specifically, the communication unit 233) (step S303).

Accordingly, at the second multi-function device 12, the communication unit 233 receives the execution instruction and transmission instruction for the resolution operation from the server device 13 (step S207). The CPU 221, upon receiving the execution instruction for the resolution operation from the server device 13, transmits the execution instruction and transmission instruction for the resolution operation from the communication unit 233 to the first multi-function device 11 (specifically, the communication unit 33) (step S208).

Accordingly, at the first multi-function device 11, the communication unit 33 receives the execution instruction and transmission instruction for the resolution operation from the second multi-function device 12 (step S109). The CPU 21, upon receiving the execution instruction for the resolution operation from the second multi-function device 12, executes the resolution operation (step S110).

The CPU 21 transmits an execution result of executing the resolution operation from the communication unit 33 to the second multi-function device 12 (specifically, the communication unit 233) and the server device 13 (specifically, the communication unit 333) (step S111).

Accordingly, at the second multi-function device 12, the communication unit 233 receives the execution result from the first multi-function device 11 (step S208), and at the server device 13, the communication unit 333 receives the execution result from the first multi-function device 11 (step S304). Specifically, the execution result is a result indicating that the communication unit 33 is now able to communicate with the communication unit 333, for example.

Additionally, in the case of receiving a job that involves communication with the server device 13, the CPU 21 executes the job (step S112). Note that in the case of not receiving a job and in the case of receiving a job that does not involve communication with the server device 13, the trouble resolution process ends without executing step S112. The trouble resolution process is executed as above in the exemplary embodiment.

### <Action in Trouble Resolution Process>

In the exemplary embodiment, as described above, when communication is unavailable between the server device 13 and the first multi-function device 11, and the communication unit 233 receives from the first multi-function device 11 a resolution request to resolve the communication trouble (step S201), and the communication unit 233 is able to communicate with the server device 13 (step S202: YES), the CPU 221 transmits the resolution request from the communication unit 233 to the server device 13 (step S203).

When the communication unit 233 receives an execution instruction for the resolution operation from the server device 13 (step S207), the execution instruction for the resolution operation is transmitted from the communication unit 233 to the first multi-function device 11 (step S208).

Accordingly, when resolving communication trouble in the first multi-function device 11, communication trouble occurring in the first multi-function device 11 is resolvable even if the communication unit 33 is unable to communicate with the server device 13. In the exemplary embodiment, communication trouble in the first multi-function device 11 is resolvable according to an execution instruction generated by the server device 13.

As a result, the communication trouble in the first multi-function device 11, which is unable to communicate with the server device 13 due to the communication trouble, is resolvable without having an engineer visit the installation location of the first multi-function device 11.

In the exemplary embodiment, communication between the first multi-function device 11 (specifically, the communication unit 33) and the server device 13 (specifically, the communication unit 333) is assumed to be communication that requires certificate verification. Also, communication between the first multi-function device 11 (specifically, the communication unit 33) and the second multi-function device 12 (specifically, the communication unit 233) is assumed to be communication that does not require certificate verification.

Consequently, according to the exemplary embodiment, when resolving communication trouble in the first multi-function device 11, communication trouble occurring in the first multi-function device 11 is resolvable even if the communication unit 33 is unable to communicate with the server device 13 due to faulty certificate verification.

In the exemplary embodiment, the CPU 221, upon receiving the execution instruction for the resolution operation from the server device 13, transmits the execution instruction and transmission instruction for the resolution operation from the communication unit 233 to the first multi-function device 11 (specifically, the communication unit 33) (step S208).

Thus, it is possible for the second multi-function device 12 and the server device 13 to ascertain the execution result of executing the execution instruction at the first multi-function device 11.

In the exemplary embodiment, when the communication unit 233 receives a resolution request from the first multi-function device 11 (step S201), and the communication unit 233 is unable to communicate with the server device 13 (step S202: NO), and the communication trouble of the communication unit 33 with respect to the server device 13 and the communication trouble of the communication unit 233 with respect to the server device 13 are the same trouble (step S204: YES), the CPU 221 notifies the first multi-function device 11 of the possibility of trouble on the network including the communication unit 233 of the second multi-function device 12 and the communication unit 33 of the first multi-function device 11 (step S206). At the first multi-function device 11, when the communication unit 33 receives the notification (step S107), the CPU 21 presents the notification to the user via the display 35 of the first multi-function device 11 (step S108).

Accordingly, it is possible to inform the user about the possibility of trouble on the network including the communication unit 33 and the communication unit 233.

In the exemplary embodiment, when communication is unavailable between the server device 13 and the communication unit 33, the CPU 21 notifies the user via the display 35 that a job involving communication with the server device 13 is unavailable for execution until the communication trouble is resolved (step S104).

Thus, it is possible to inform the user that a job involving communication with the server device 13 is unavailable for execution until the communication trouble is resolved.

In the exemplary embodiment, if the job for which an execution instruction has been received is a job that does not involve communication with the server device 13, the CPU 21 executes the job before executing a resolution operation to resolve communication trouble. On the other hand, if the job for which an execution instruction has been received is a job that involves communication with the server device 13, the CPU 21 executes the job after executing a resolution operation to resolve communication trouble.

Thus, job execution may be completed earlier compared to the case of executing all jobs after executing a resolution operation.

### <Exemplary Modification of Trouble Resolution Process in Executing System 10>

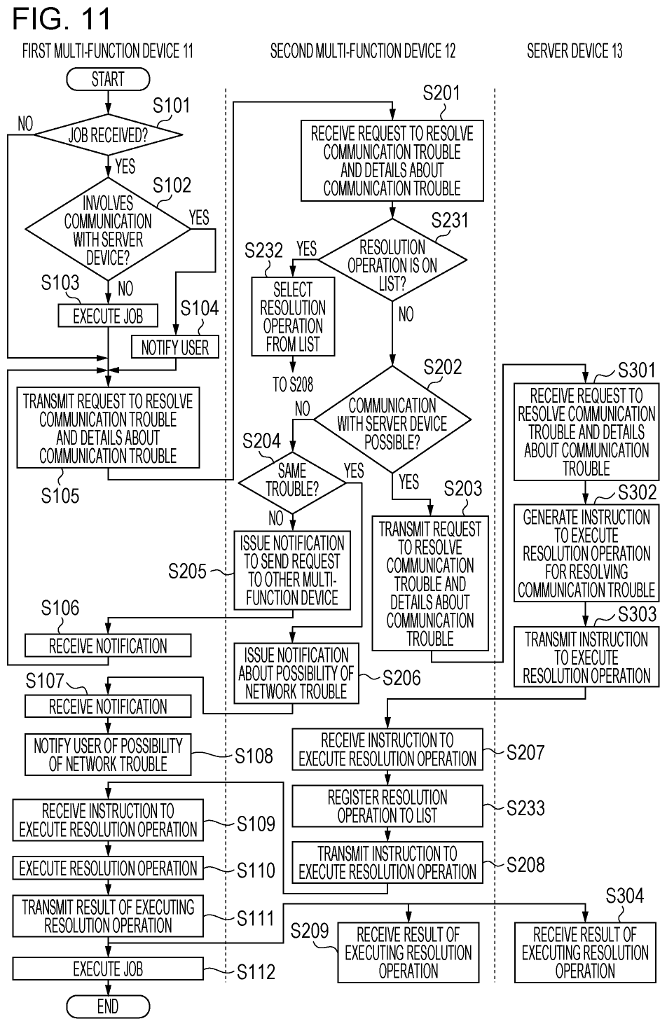

Next, an exemplary modification of the trouble resolution process executed in the executing system 10 (hereinafter referred to as the second trouble resolution process) will be described. FIG. 11 is a flowchart illustrating an example of the flow of the second trouble resolution process. In the following, portions that differ from the flow of the trouble resolution process illustrated in FIG. 8 (hereinafter referred to as the first trouble resolution process) will be described, while portions similar to the flow of the first trouble resolution process will be omitted from description where appropriate.

In the executing system 10 that executes the second trouble resolution process, the storage 224 in a second multi-function device 12 that serves as a master device representing the multiple second multi-function devices 12 retains a list of information on resolution operations corresponding to each of multiple communication troubles.

Like the case of the first trouble resolution process, in the first multi-function device 11, the CPU 21 determines whether the communication unit 33 is able to communicate with the server device 13 (specifically, the communication unit 333), and if the CPU 21 determines that the communication unit 33 is unable to communicate with the communication unit 333, the executing system 10 executes the second trouble resolution process.

In step S105, the CPU 21 transmits a resolution request from the communication unit 33 to the second multi-function device 12 retaining the list of information on resolution operations corresponding to each of multiple communication troubles from among the multiple second multi-function devices 12.

When the communication unit 233 receives the resolution request and the details about the communication trouble from the first multi-function device 11, the CPU 221 determines whether a resolution operation corresponding to the communication trouble pertaining to the resolution request exists on the information list (step S231).

In the case of determining that a resolution operation corresponding to the communication trouble pertaining to the resolution request exists on the information list (step S231: YES), the CPU 221 selects the resolution operation corresponding to the communication trouble pertaining to the resolution request from the information list (step S232), and transmits an execution instruction to execute the selected resolution operation from the communication unit 233 to the first multi-function device 11 (step S208). Accordingly, at the first multi-function device 11, the communication unit 33 receives, from the second multi-function device 12, the transmission instruction and the execution instruction to execute the resolution operation selected from the information list (step S109).

On the other hand, in the case of determining that a resolution operation corresponding to the communication trouble pertaining to the resolution request does not exist on the information list (step S231: NO), the CPU 221 determines whether the communication unit 233 is able to communicate with the server device 13 (specifically, the communication unit 333) (step S202).

Also, when the communication unit 233 receives an execution instruction from the server device 13 in step S207, the CPU 221 registers a resolution operation pertaining to the execution instruction to the information list (step S233), and transmits an execution instruction to execute the resolution operation from the communication unit 233 to the first multi-function device 11 (step S208).

### <Action in Second Trouble Resolution Process>

In the second trouble resolution process, as described above, when the communication unit 233 receives a resolution request and details about communication trouble from the first multi-function device 11, and a resolution operation corresponding to the communication trouble pertaining to the resolution request exists on the information list (step S231: YES), the CPU 221 selects the resolution operation corresponding to the communication trouble pertaining to the resolution request from the information list (step S232), and transmits an execution instruction to execute the selected resolution operation from the communication unit 233 to the first multi-function device 11 (step S208).

Thus, it is possible to resolve trouble in the first multi-function device 11 without transmitting a resolution request from the second multi-function device 12 to the server device 13.

In the second trouble resolution process, as described above, if a resolution operation corresponding to the communication trouble pertaining to the resolution request does not exist on the information list (step S231: NO), and the communication unit 233 is able to communicate with the server device 13 (specifically, the communication unit 333), the CPU 221 transmits the resolution request from the communication unit 233 to the server device 13 (step S203).

When the communication unit 233 receives an execution instruction for the resolution operation from the server device 13 (step S207), the execution instruction for the resolution operation is transmitted from the communication unit 233 to the first multi-function device 11 (step S208).

This arrangement makes it possible to resolve communication trouble in the first multi-function device 11 even when a resolution operation corresponding to the communication trouble occurring in the first multi-function device 11 does not exist on the information list.

In the second trouble resolution process, as described above, when the communication unit 233 receives an execution instruction from the server device 13 in step S207, the CPU 221 registers a resolution operation pertaining to the execution instruction to the information list (step S233), and transmits an execution instruction to execute the resolution operation from the communication unit 233 to the first multi-function device 11 (step S208).

The above thus addresses the situation in which a resolution operation corresponding to communication trouble occurring in the first multi-function device 11 does not exist on the information list.

### <Exemplary Modifications>

In the exemplary embodiment, a multi-function device (specifically, the first multi-function device 11 and the second multi-function devices 12) is used as an example of an information processing system, but the configuration is not limited thereto. The example of an information processing system may also be a device such as a printer that only executes print processes, and an image forming device other than an all-in-one machine may be used. Moreover, the example of an information processing system is not limited to an image forming device, and a device that executes jobs involving predetermined processes according to instructions from a user may be used.

In the exemplary embodiment, the server device 13 is used as an example of a device prioritized to communicate with when the first multi-function device 11 resolves trouble, but the configuration is not limited thereto. The device may also be a multi-function device or other image forming device, a personal computer, or a smartphone or other terminal, and may be any device capable of communication.

The present disclosure is not limited to the exemplary embodiment above, and various modifications, alterations, and improvements are possible without deviating from the gist of the present disclosure. For example, the exemplary modifications described above may also be plurally combined, as appropriate.

In the exemplary embodiment, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

In the exemplary embodiment, the executing system is described as a configuration formed by multiple devices, but may also be a configuration formed by a single device. In the exemplary embodiment, the information processing system is described as a configuration formed by a single device, but may also be a configuration formed by multiple devices. In other words, a “system” in the exemplary embodiment may be a configuration formed by multiple devices or a configuration formed by a single device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))

An information processing system comprising:
a communication unit; and
a processor,
wherein the processor is configured to transmit an execution instruction when the communication unit receives a resolution request to resolve communication trouble from another information processing system in a case where the other information processing system is unable to communicate with a device prioritized to communicate with when the other information processing system resolves trouble,
the execution instruction being an instruction to execute a resolution operation to resolve the trouble from the communication unit to the other information processing system.
   (((2)))

The information processing system according to (((1))), wherein:
communication between the other information processing system and the device is communication that requires certificate verification, and
communication between the other information processing system and the communication unit is communication that does not require certificate verification.
   (((3)))

The information processing system according to (((1))) or (((2))), wherein:
when the communication unit receives the resolution request from the other information processing system,
the processor is configured to transmit the resolution request from the communication unit to the device, and
when the communication unit receives the execution instruction from the device,
the processor is configured to transmit the execution instruction from the communication unit to the other information processing system.
   (((4)))

The information processing system according to (((3))), wherein the processor is configured to transmit the execution instruction, together with a transmission instruction to transmit to the communication unit an execution result of executing the execution instruction, from the communication unit to the other information processing system.

(((5)))

The information processing system according to (((3))) or (((4))), wherein when the communication unit receives the resolution request from the other information processing system, and the communication unit is unable to communicate with the device, the processor is configured to notify a user, via a notifier, of the possibility of trouble on a network including the communication unit and the communication unit of the other information processing system.

(((6)))

The information processing system according to any one of (((1))) to (((5))), wherein:
the information processing system retains a list of information on resolution operations corresponding to each of a plurality of troubles, and
when the communication unit receives the resolution request from the other information processing system, the processor is configured to:
   select from the information list the resolution operation corresponding to trouble pertaining to the resolution request; and
   transmit an execution instruction to execute the resolution operation from the communication unit to the other information processing system.
      (((7)))

The information processing system according to (((6))), wherein:
when the communication unit receives the resolution request from the other information processing system, and the resolution operation corresponding to trouble pertaining to the resolution request does not exist on the information list, the processor is configured to transmit the resolution request from the communication unit to the device, and
when the communication unit receives the execution instruction from the device,
the processor is configured to transmit the execution instruction from the communication unit to the other information processing system.
   (((8)))

The information processing system according to (((7))), wherein:
when the communication unit receives the execution instruction from the device,
the processor is configured to register the resolution operation pertaining to the execution instruction to the information list, and transmit the execution instruction to the other information processing system.
   (((9)))

An information processing system comprising:
a communication unit; and
a processor,
wherein:
   when the communication unit is unable to communicate with a device prioritized to communicate with when the information processing system resolves trouble, the processor is configured to transmit a resolution request to resolve the trouble from the communication unit to a different information processing system; and
   when the communication unit receives from the different information processing system an execution instruction to execute a resolution operation to resolve the trouble, the processor is configured to execute the resolution operation.
      (((10)))

The information processing system according to (((9))), wherein:
when the communication unit is unable to communicate with a device prioritized to communicate with when the information processing system resolves trouble, the processor is configured to transmit the resolution request from the communication unit to a different information processing system retaining a list of information on resolution operations corresponding to each of a plurality of troubles from among a plurality of different information processing systems; and
when the communication unit receives from the different information processing system an execution instruction to execute a resolution operation selected from the information list, the processor is configured to execute the resolution operation.
   (((11)))

The information processing system according to (((9))) or (((10))), wherein the processor is configured to:
accept a job execution instruction from a user; and
when the communication unit is unable to communicate with a device prioritized to communicate with when the information processing system resolves trouble, the processor is configured to transmit a resolution request to resolve the trouble from the communication unit to a different information processing system, and notify the user, via a notifier, that the job involving communication with the device is unavailable for execution until the trouble is resolved.
   (((12)))

The information processing system according to any one of (((9))) to (((11))), wherein when the processor accepts a job execution instruction from a user in a case where the communication unit is unable to communicate with the device prioritized to communicate with when the information processing system resolves trouble, the processor is configured to:
execute the job before executing the resolution operation if the job does not involve communication with the device; and
execute the job after executing the resolution operation if the job involves communication with the device.
   (((13)))

An information processing program causing a computer to execute a process comprising:
transmitting an execution instruction when a communication unit of an information processing system receives a resolution request to resolve communication trouble from another information processing system in a case where the other information processing system is unable to communicate with a device prioritized to communicate with when the other information processing system resolves trouble,
the execution instruction being an instruction to execute a resolution operation to resolve the trouble from the communication unit to the other information processing system.

What is claimed is:

1. An information processing system comprising:
a communication unit; and
a processor,
wherein the processor is configured to transmit an execution instruction when the communication unit receives a resolution request to resolve communication trouble from another information processing system in a case where the other information processing system is unable to communicate with a device prioritized to communicate with when the other information processing system resolves trouble,
the execution instruction being an instruction to execute a resolution operation to resolve the trouble from the communication unit to the other information processing system.

2. The information processing system according to claim 1, wherein:
communication between the other information processing system and the device is communication that requires certificate verification; and
communication between the other information processing system and the communication unit is communication that does not require certificate verification.

3. The information processing system according to claim 1, wherein:
when the communication unit receives the resolution request from the other information processing system,
the processor is configured to transmit the resolution request from the communication unit to the device, and
when the communication unit receives the execution instruction from the device,
the processor is configured to transmit the execution instruction from the communication unit to the other information processing system.

4. The information processing system according to claim 3, wherein the processor is configured to transmit the execution instruction, together with a transmission instruction to transmit to the communication unit an execution result of executing the execution instruction, from the communication unit to the other information processing system.

5. The information processing system according to claim 3, wherein when the communication unit receives the resolution request from the other information processing system, and the communication unit is unable to communicate with the device, the processor is configured to notify a user, via a notifier, of the possibility of trouble on a network including the communication unit and the communication unit of the other information processing system.

6. The information processing system according to claim 1, wherein:
the information processing system retains a list of information on resolution operations corresponding to each of a plurality of troubles, and
when the communication unit receives the resolution request from the other information processing system, the processor is configured to:
select from the information list the resolution operation corresponding to trouble pertaining to the resolution request; and
transmit an execution instruction to execute the resolution operation from the communication unit to the other information processing system.

7. The information processing system according to claim 6, wherein:
when the communication unit receives the resolution request from the other information processing system, and the resolution operation corresponding to trouble pertaining to the resolution request does not exist on the information list, the processor is configured to transmit the resolution request from the communication unit to the device, and
when the communication unit receives the execution instruction from the device,
the processor is configured to transmit the execution instruction from the communication unit to the other information processing system.

8. The information processing system according to claim 7, wherein:
when the communication unit receives the execution instruction from the device,
the processor is configured to register the resolution operation pertaining to the execution instruction to the information list, and transmit the execution instruction to the other information processing system.

9. An information processing system comprising a communication unit and a processor, wherein:
when the communication unit is unable to communicate with a device prioritized to communicate with when the information processing system resolves trouble, the processor is configured to transmit a resolution request to resolve the trouble from the communication unit to a different information processing system, and
when the communication unit receives from the different information processing system an execution instruction to execute a resolution operation to resolve the trouble, the processor is configured to execute the resolution operation.

10. The information processing system according to claim 9, wherein:
when the communication unit is unable to communicate with a device prioritized to communicate with when the information processing system resolves trouble, the processor is configured to transmit the resolution request from the communication unit to a different information processing system retaining a list of information on resolution operations corresponding to each of a plurality of troubles from among a plurality of different information processing systems, and
when the communication unit receives from the different information processing system an execution instruction to execute a resolution operation selected from the information list, the processor is configured to execute the resolution operation.

11. The information processing system according to claim 9, wherein the processor is configured to:
accept a job execution instruction from a user; and
when the communication unit is unable to communicate with a device prioritized to communicate with when the information processing system resolves trouble, the processor is configured to transmit a resolution request to resolve the trouble from the communication unit to a different information processing system, and notify the user, via a notifier, that the job involving communication with the device is unavailable for execution until the trouble is resolved.

12. The information processing system according to claim 9, wherein when the processor accepts a job execution instruction from a user in a case where the communication unit is unable to communicate with the device prioritized to communicate with when the information processing system resolves trouble, the processor is configured to:
execute the job before executing the resolution operation if the job does not involve communication with the device; and
execute the job after executing the resolution operation if the job involves communication with the device.

13. A non-transitory computer readable medium storing a program causing a computer to execute a process comprising:
transmitting an execution instruction when a communication unit of an information processing system receives a resolution request to resolve communication trouble from another information processing system in a case where the other information processing system is unable to communicate with a device prioritized to communicate with when the other information processing system resolves trouble,
the execution instruction being an instruction to execute a resolution operation to resolve the trouble from the communication unit to the other information processing system.
